(19) United States
(12) Patent Application Publication
(10) Pub. No.: US 2023/0150876 A1
(43) Pub. Date: May 18, 2023

(54) ADDITIVE FOR CEMENT-FREE BUILDING MATERIALS

(71) Applicant: ETH Zürich, Zürich (CH)

(72) Inventors: Gnanli LANDROU, Zürich (CH); Coralie BRUMAUD, Bienne (CH); Guillaume HABERT, Zürich (CH)

(73) Assignee: ETH Zürich, Zürich (CH)

(21) Appl. No.: 17/910,706

(22) PCT Filed: Mar. 11, 2020
(86) PCT No.: PCT/EP2020/056531

§ 371 Date: Sep. 9, 2022

(51) Int. Cl. C04B 28/00; C04B 40/00; C04B 22/06; C04B 22/16; C04B 22/00

(52) U.S. Cl. CPC C04B 28/001; C04B 22/16; C04B 22/066; C04B 22/0093; C04B 40/0039; C04B 2111/1037

(57) ABSTRACT

An additive for producing a hardenable building material, especially a mineral composition comprising clays, comprising or consisting of: a) a dispersing agent, selected from aluminates, aluminate precursors, phosphates, silicates and/or polyacrylates, which is capable of dispersing clay particles in an aqueous slurry, and b) a coagulating agent, selected from salts of divalent metal cations, preferably salts of alkaline earth metals and/or iron, especially magnesium, calcium and/or iron salts, capable of causing clay particles to agglomerate in a aqueous slurry.

### TECHNICAL FIELD

The invention relates to an additive for producing a hardenable building material, especially a mineral composition comprising clays. Furthermore, the invention is concerned with an aqueous slurry and a hardened composition prepared from the aqueous slurry. An additional aspect of the invention relates to the use of the additive for producing a solid building material, preferably substantially free of hydraulic binder, from a mineral fraction comprising clay particles, especially a mineral fraction from soil.

### BACKGROUND ART

In the field of construction, one of the most widely used inorganic building material is concrete. Concrete typically is made of cement as a hydraulic binder, aggregates and water.

However, the production of cement requires large amounts of energy and generates a considerable amount climate relevant CO₂. In order to reduce energy consumption and CO₂ emissions, cement in mineral binder compositions can be partially replaced by latent hydraulic and/or pozzolanic materials, such as fly ash, slag or silica fume. Such cement replacements arise as by-products in various industrial processes and are therefore advantageous, for example in terms of CO₂ balance. However, setting of compositions comprising considerable proportions of such kind of cement replacements usually takes much longer and workability might be affected negatively as well.

In order to overcome these drawbacks, it is known to use special additives, such as setting accelerators, viscosity modifiers or plasticizers, which can partly compensate the negative effects of cement replacements. However, these additives all are designed for cement-based compositions, typically comprising neat aggregates. When they are for example used in compositions comprising clays and fines, their effectivity might diminish drastically.

In the ideal case, it would be preferable to provide a construction material which is completely free of cement and that can be obtained with the resources naturally present near the construction site, with the use of a minimum of auxiliary products and energy. However, with the additives known so far, it is hardly possible to achieve this goal in a satisfactory manner.

There is thus a need to provide improved solutions, which overcome the aforementioned drawbacks.

### DISCLOSURE OF THE INVENTION

It is an object of the present invention to provide solutions which allow for providing mortar- or concrete-like building materials with as little cement, auxiliary products and energy as possible. Preferably, the building materials shall have a workability and/or setting behavior similar to ordinary cement-based mortar, grout or concrete compositions.

Surprisingly it was found that these objects can be achieved with an additive according to claim 1. With the inventive additives, it possible to produce cement-free building materials, which are essentially based on resources naturally present near the construction sites, such as e.g. naturally occurring clay containing soil. Thereby, the setting behavior and workability are very similar to ordinary cement-based concrete, mortar or grout compositions. Thus, there is no need to adapt construction procedures and/or tools already known and used for ordinary building materials.

With the inventive additives, it is for example possible to produce cement-free clay based workable compositions which can be used for producing non-fired as well as fired bricks with an improved compressive strength when compared with conventional clay bricks.

Further aspects of the present invention are subject of other independent claims. Preferred embodiments of the invention are subject of dependent claims.

### DETAILED DESCRIPTION OF THE INVENTION

A first aspect of the present invention is concerned with an additive for producing a hardenable building material, especially a mineral binder composition comprising clays, comprising or consisting of:
a) a dispersing agent, selected from aluminates, aluminate precursors, phosphates, silicates and/or polyacrylates, which is capable of dispersing clay particles in an aqueous slurry, and
b) a coagulating agent, selected from salts of divalent metal cations, preferably salts of alkaline earth metals and/or iron, especially magnesium, calcium and/or iron salts, capable of causing clay particles to agglomerate in a aqueous slurry.

In the present context, substances, such as aluminates, aluminate precursors, phosphates, silicates and/or polyacrylates, which are capable of dispersing clay particles in an aqueous slurry, are also called “dispersing substances” or “dispersants”.

Substances, such as salts of divalent metal cations, which are capable of causing clay particles to agglomerate in an aqueous slurry are also called “coagulating substances”.

The term “aluminates” includes anhydrous aluminates as well as corresponding hydrated aluminates.

The term “aluminate precursors” stands for substances, which in the presence of water can react under basic conditions and/or in the presence of a base to form aluminates. Basic conditions mean a pH > 7, especially > 9. An example of an aluminate precursor is alumina or aluminum oxide (Al₂O₃), respectively.

Preferably, the selected dispersant is an alkali metal salt, especially a sodium and/or potassium salt, preferably a sodium salt. Thus, preferably, the dispersant is an alkali metal aluminate salt, an alkali metal phosphate salt, an alkali metal silicate salt and/or alkali metal polyacrylate salt. Thereby, the sodium and/or potassium salts are preferred, especially the sodium salts.

According to a preferred embodiment, the dispersing agent comprises a phosphate, especially a polymetaphosphate, in particular an alkali metal polymetaphosphate.

Especially, the dispersing agent comprises a hexametaphosphate, more preferably an alkali metal hexametaphosphate, in particular sodium hexametaphosphate.

In another preferred embodiment, the dispersing agent comprises a silicate, especially an alkali metal silicate. The alkali metal silicate preferably is selected from sodium silicate and/or potassium silicate, most preferred from sodium silicate.

The sodium silicate preferably has a ratio of SiO₂:Na₂O in the range of 1 - 2.8. The potassium silicate preferably has a ratio of SiO₂:K₂O in the range of 1 - 2.8.

In particular, the silicate is sodium metasilicate and/or sodium orthosilicate, especially sodium metasilicate. Sodium metasilicate can be represented by the formula Na₂SiO₃, whereas sodium orthosilicate can be represented by the formula Na₄SiO₄.

According to another preferred embodiment, the dispersant comprises an aluminate and/or an aluminate precursor, especially the dispersant comprises NaAlO₂, Na₂Al₂O₄ and/or Al₂O₃. Thereby, hydrated forms of the aluminates are included as well.

In another preferred embodiment the dispersing agent comprises a polyacrylate, especially an alkali metal polyacrylate and/or an ammonium polyacrylate, most preferred a sodium polyacrylate. Especially, the polyacrylate has an average molecular weight M_{w} of 500 -50′000 g/mol, in particular 1′000 - 20′000 g/mol. The molecular weight M_{w} is determined by gel permeation chromatography (GPC) at 20° C. with polyethylenglycol (PEG) as standard.

Especially preferred, the dispersing agent comprises a phosphate and a further dispersing substance from the group of consisting of aluminates, aluminate precursors, silicates and/or polyacrylates. Thereby, the further dispersing substances are defined as described above.

Put differently, in this highly preferred embodiment, the dispersing agent comprises at least two different dispersing substances, namely a phosphate and at least one representative of the group of aluminates, aluminate precursors, silicates and/or polyacrylates. In this case, a very high dispersing effect can be achieved in a variety of different clay containing aqueous slurries.

In this embodiment, preferably, a weight proportion of the phosphate is higher than a weight proportion of the further dispersing substance.

Especially, a weight ratio of the phosphate to the further dispersing substance is in the range of 0.5 - 10, especially 1 - 7, in particular 1.5 - 5, especially preferred 2 - 4.

In particular, the dispersing agent comprises (i) a phosphate and (ii) a silicate and/or an aluminate.

Especially the dispersing agent comprises (i) a polymetaphosphate, especially a hexametaphosphate, in particular sodium hexametaphosphate, and (ii) sodium silicate and/or sodium aluminate. Thereby, the weight ratio of the phosphate is chosen as described above, especially with the weight proportion of the phosphate being higher than the weight proportion of the silicate and/or the aluminate.

In particular, the dispersing agent comprises a phosphate and a silicate, especially hexametaphosphate and sodium silicate.

Especially, the dispersing agent comprises a phosphate and an aluminate, especially hexametaphosphate and sodium aluminate.

Furthermore, the dispersing agent preferably comprises a pozzolanic compound, especially fly ash. As it turned out, the addition of a pozzolanic compound, especially fly ash, allows for reducing the proportion of the dispersing agent while keeping the dispersing effect at a similar level. Thus, the pozzolanic compound, especially the fly ash can be used to increase the dispersing effect of the dispersing agent. This is in particular true when the dispersing agent comprises phosphates, especially hexametaphosphate, in particular sodium hexametaphosphate.

Thus, according to a highly preferred embodiment, the dispersing agent comprises a phosphate, in particular polymetaphosphate, especially hexametaphosphate, preferably sodium hexametaphosphate, and a pozzolanic compound, especially fly ash.

Especially, a weight ratio of the pozzolanic compound, in particular the fly ash, to the other dispersing substances, especially the phosphate, is in the range of 1 - 15, especially 2 -10, preferably 3 - 7.

The dispersing agent can be present in solid state, in the form of an aqueous dispersion or in the form of an aqueous solution.

Especially, a particle size of the dispersing agent is ≤ 1 ′100 µm, especially, ≤ 1 ′000 µm, in particular ≤ 500 µm, preferably ≤ 200 µm. By choosing an appropriate particle size within these ranges, it is possible to improve the dispersing effect of the agent. Thereby, especially, a minimum particle size is 0.5 µm, preferably 1 µm, in particular 50 µm.

The dispersing agent can be of industrial grade, e.g. with a purity of at least 55% by weight, especially 60 - 70% by weight. However, it is preferred to use dispersing agents with purities of at least 85% by weight, more preferably of at least 95% by weight, with respect to the overall weight of the dispersing agent.

Without being bound by theory, it is believed that the addition of the coagulating agent accelerates the setting of a slurry containing clay particles by releasing divalent ions, such as magnesium, calcium and/or iron, which have the ability to form precipitates such as crystals that can increase mechanical properties such as compressive strength in the final building material.

Preferably, the coagulating agent is selected from earth-alkaline metal salts, slag, fly ash, wood ash and/or cement, especially from earth-alkaline metal oxides, hydroxides, chlorides, carbonates, and/or sulfates. Earth-alkaline metal salts are highly preferred.

More preferred, the coagulating agent is selected from MgO, CaO, Ca(OH)₂, Mg(OH)₂, CaCO₃, CaSO₄, CaSO₄ • 2 H₂O, CaCl₂, MgSO₄, slag, fly ash, wood ash and/or cement.

When rapid setting, i.e. within less than one hour is desired, the coagulating agent is preferably selected from halides and nitrates, e.g. chlorides, of alkaline earth metals such as magnesium chloride, calcium chloride, calcium nitrate and/or magnesium nitrate.

However, when prolonged workability, i.e. more than one hour and preferably more than 4 hours is desired, the coagulating agent is preferably selected from oxides, hydroxides, carbonates and/or sulphates of alkaline earth metals, such as for example from magnesium oxide, calcium oxide, magnesium hydroxide, calcium hydroxide, magnesium carbonate and/or calcium carbonate.

Especially the coagulating agent comprises or consists of magnesium oxide and/or calcium oxide, preferably magnesium oxide. In particular, the coagulating agent comprises or consists of MgO and/or CaO, preferably MgO.

According to another preferred embodiment, the coagulating agent furthermore comprises a pozzolanic compound, especially fly ash. As it turned out, pozzolanic compounds in appropriate proportions can help to introduce coagulation in certain excavation materials.

According to a preferred embodiment, the coagulating agent comprises an earth-alkaline metal oxide, especially magnesium oxide, and a pozzolanic compound, especially fly ash.

Preferably, a weight ratio of the pozzolanic compound, especially fly ash, to the other coagulating substances, especially the earth-alkaline metal oxide, is in the range of 1 - 20, especially 2 - 15, preferably 3 - 12.

The coagulating agent can be present in solid state, in the form of an aqueous dispersion or in the form of an aqueous solution.

Especially, if a rapid setting is required, e.g. within less than one hour, the coagulating agent can be added in the form of an aqueous dispersion or an aqueous solution. Thereby, preferably, the coagulating agent comprises halides, oxides, hydroxides, carbonates, and/or sulphates.

According to a preferred embodiment, the coagulating agent comprises solid particles having a specific surface area of at least 20 m²/g, especially 30 - 8′000 m²/g, in particular 100 - 6′000 m²/g. Thereby, the can be present in the form of a powder of the solid particles or in the form of an aqueous dispersion comprising the solid particles. The specific surface is defined and measured according to the Blaine method in line with standard EN 196-6:2019. This is beneficial if a rapid setting is required.

Especially, a particle size of the coagulating agent is ≤ 1′100 µm, especially, ≤ 1′000 µm, in particular ≤ 500 µm, preferably ≤ 100 µm. By choosing an appropriate particle size within these ranges, it is possible to improve the coagulating effect of the agent. Especially, a minimum particle size of the coagulating agent is 0.5 µm, preferably 1 µm, in particular 50 µm.

If the coagulating agent comprises MgO, the particle size of the MgO preferably is 0.5 -500 µm, in particular 1 - 100 µm.

If the coagulating agent comprises CaO, the particle size of the CaO preferably is 0.5 -1′000 µm, in particular 0.5 - 200 µm.

If the coagulating agent comprises Ca(OH)₂, the particle size of the Ca(OH)₂ preferably is 100 - 1′000 µm.

If the coagulating agent comprises CaCO₃, the particle size of the CaCO₃ preferably is 0.5 -1′000 µm, in particular 0.5 - 200 µm.

Most preferred, coagulating agents with these particles sizes are combined with dispersing agents with the above mentioned particle sizes. Such combinations improve the overall performance of the additive significantly.

For example, coagulating agents with particle sizes ≤ 1′100 µm are combined with dispersing agents having a particle size ≤ 1′100 µm. More preferred, coagulating agents with particle sizes ≤ 500 µm are combined with dispersing agents having a particle size ≤ 500 µm. Thereby, preferably, a minimum particle size of the coagulating agents and the dispersing agents are 0.5 µm, preferably 1 µm, in particular 50 µm.ln the additive, preferably, a weight ratio of the dispersing agent to the coagulating agent is in the range of 0.1 - 10, especially 0.3 - 5, in particular 0.5 - 2, especially in the range of 0.7 - 1.5.

If the dispersing agent is selected from phosphates and the coagulating agent is selected from inorganic salts having a divalent metal cation, especially earth-alkaline oxides, the molar ratio of the number of all of the divalent metal cations of the inorganic salts to the number of all of the phosphorous groups in all of the phosphates preferably is greater than 1 and more preferably greater than 2, most preferred, the molar ration is between 2 and 5. Put differently, generally, the metal cation of the inorganic salt is present in a molar excess relative to the phosphorous groups present in all of the phosphates.

For example, if the dispersing agent is sodium hexametaphosphate (NaPO₃)₆, each hexametaphosphate comprises six phosphorous groups comprising a central phosphor atom, which is bound on average to three oxygen atoms, i.e. six NaPO₃ monomers.

In a preferred embodiment, the dispersing agent consists of at least one phosphate, at least one silicate, or mixtures thereof, more preferably sodium hexametaphosphate, sodium silicate or a mixture of sodium hexametaphosphate and sodium silicate and/or the coagulating agent consists of magnesium oxide, calcium hydroxide or a mixture of magnesium oxide and calcium hydroxide.

Especially, if the if the dispersing agent is selected from polymetaphosphates, especially hexametaphosphates, and the coagulating agent is selected from earth-alkaline oxides, especially magnesium oxide, the molar ratio of the number of all of the magnesium cations to the number of all of the phosphorous groups in hexametaphosphates preferably is greater than 1 and more preferably greater than 2, most preferred, the molar ration is between 2 and 5.

For example, in the case where the dispersing agent is selected from silicates such as sodium silicate and the coagulating agent is selected from alkaline earth metal salts such as calcium oxide, the precipitation manifests itself as hydrated calcium silicate crystals, such as e.g. plomberite. In the case where the dispersing agent is selected from phosphates such as hexametaphosphate and the coagulating agent is selected from alkaline earth metal salts such as calcium oxide, the precipitation occurs in crystals of hydrated calcium silicate such as apatite.

Similarly, when the dispersing agent is selected from phosphates such as hexametaphosphate and the coagulating agent is selected from salts of alkaline earth metals such as magnesium oxide, the precipitations occur as crystals of magnesium silicate.

Without wishing to be bound by theory, it is believed that the rapid rise in compressive strength which takes place in aqueous slurries shortly after the addition of the coagulating agent and during hardening derives from this precipitation formation which consumes the dispersing agent present in the aqueous building material slurry and eliminates the electrostatic repulsion generated by adsorption of the dispersing agent on the clay particles. The rapid rise in compressive strength which occurs in aqueous building material slurries shortly after the addition of the coagulating agent and during hardening saves the time required to manufacture a building material component.

A first advantageous additive comprises a phosphate, especially a hexametaphosphate, in particular sodium hexametaphosphate, as the dispersant and an earth-alkaline metal oxide, especially magnesium oxide, as the coagulating agent.

A second advantageous additive comprises:
a) as dispersing agent: a phosphate, in particular a polymetaphosphate, especially a hexametaphosphate, and a further dispersant from the group of consisting of aluminates, aluminate precursors, silicates and/or polyacrylates, and
b) as coagulating agent: a magnesium oxide and/or calcium oxide, especially magnesium oxide.

In a third preferred additive, the dispersing agent comprises hexametaphosphate, especially sodium hexametaphosphate, and a further dispersing substance from the group consisting of aluminates, aluminate precursors, silicates, and the coagulating agent comprises magnesium oxide.

In these preferred additives, a weight ratio of the phosphate to the further dispersing substance preferably is in the range of 0.5 - 10, especially 1 - 7, in particular 1.5 - 5, especially preferred 2 - 4.

Furthermore, in these preferred additives, the dispersing agent preferably comprises (i) a phosphate and (ii) a silicate and/or an aluminate. Especially the dispersing agent comprises (i) hexametaphosphate, in particular sodium hexametaphosphate, and (ii) sodium silicate and/or sodium aluminate.

According to a fourth preferred embodiment, the additive comprises or consists of:
a) a dispersant comprising:
   a phosphate, especially hexametaphosphate, in particular sodium hexametaphosphate;
   a silicate and/or an aluminate, especially an alkali metal silicate and/or an alkali metal aluminate, in particular a sodium silicate and/or sodium aluminate;
   whereby a weight ratio of the phosphate to the silicate and/or the aluminate is in the range of 0.5 - 10, especially 1 - 7, in particular 1.5 - 5, especially preferred 2 - 4;
   optionally a pozzolanic compound, especially fly ash;
   whereby, if a pozzolanic compound is present, a weight ratio of the pozzolanic compound, in particular the fly ash, to the other dispersing substances is in the range of 1 - 15, especially 2 - 10, preferably 3-7;
b) a coagulating agent comprising:
   an earth-alkaline metal oxide, especially magnesium oxide and/or calcium oxide, preferably magnesium oxide
   optionally a pozzolanic substance, especially fly ash
   whereby, if a pozzolanic compound is present, a weight ratio of the pozzolanic compound, especially fly ash, to the other coagulating substances, especially the earth-alkaline metal oxide, is in the range of 1 - 20, especially 2 - 15, preferably 3 - 12; and
   whereby a weight ratio of the dispersing agent to the coagulating agent is in the range of 0.1 - 10, especially 0.3 - 5, in particular 0.5 - 2, especially in the range of 0.7 - 1.5.

According to a fifth preferred embodiment, the additive comprises or consists of:
a) a dispersant comprising:
   sodium hexametaphosphate;
   sodium silicate and/or sodium aluminate;
   whereby a weight ratio of the phosphate to the silicate and/or the aluminate is in the range of 1.5 - 5, especially preferred 2 - 4;
   optionally a pozzolanic compound, especially fly ash;
   whereby, if a pozzolanic compound is present, a weight ratio of the pozzolanic compound, in particular the fly ash, to the other dispersing substances is in the range of 3 - 7;
b) a coagulating agent comprising:
   magnesium oxide
   optionally a pozzolanic substance, especially fly ash
   whereby, if a pozzolanic compound is present, a weight ratio of the pozzolanic compound, especially fly ash, to the other coagulating substances, especially the earth-alkaline metal oxide, is in the range of 3 - 12; and
   whereby a weight ratio of the dispersing agent to the coagulating agent is in the range of 0.5 - 2, especially in the range of 0.7 - 1.5.

According to a sixth preferred embodiment, the additive comprises or consists of:
a) a dispersant comprising:
   sodium hexametaphosphate;
   sodium silicate;
   whereby a weight ratio of the phosphate to the silicate is in the range of 2 - 4;
   optionally a pozzolanic compound, especially fly ash;
   whereby, if a pozzolanic compound is present, a weight ratio of the pozzolanic compound, in particular the fly ash, to the other dispersing substances is in the range of 3 - 7;
b) a coagulating agent comprising:
   magnesium oxide
   optionally a pozzolanic substance, especially fly ash
   whereby, if a pozzolanic compound is present, a weight ratio of the pozzolanic compound, especially fly ash, to the other coagulating substances, especially the earth-alkaline metal oxide, is in the range of 3 - 12; and
   whereby a weight ratio of the dispersing agent to the coagulating agent is in the range of 0.7 - 1.5.

According to a seventh preferred embodiment, the additive comprises or consists of:
a) a dispersant comprising:
   sodium hexametaphosphate;
   sodium aluminate;
   whereby a weight ratio of the phosphate to the aluminate is in the range of 2 - 4;
   optionally a pozzolanic compound, especially fly ash;
   whereby, if a pozzolanic compound is present, a weight ratio of the pozzolanic compound, in particular the fly ash, to the other dispersing substances is in the range of 3 - 7;
b) a coagulating agent comprising:
   magnesium oxide
   optionally a pozzolanic substance, especially fly ash
   whereby, if a pozzolanic compound is present, a weight ratio of the pozzolanic compound, especially fly ash, to the other coagulating substances, especially the earth-alkaline metal oxide, is in the range of 3 - 12; and
   whereby a weight ratio of the dispersing agent to the coagulating agent is in the range of 0.7 - 1.5.

In all of the above described embodiments, preferably, the coagulating agents have particle sizes ≤ 1′100 µm and/or the dispersing agents have particles size ≤ 1′100 µm. Especially both conditions hold.

More preferred, the coagulating agents have particle sizes ≤ 500 µm and the dispersing agents have particle sizes ≤ 500 µm. Especially both conditions hold.

Thereby, preferably, a minimum particle size of the coagulating agents and the dispersing agents are 0.5 µm, preferably 1 µm, in particular 50 µm.

Preferably, the additive is a kit-of-parts being present in the form of a multi-component composition, especially a two-component composition, comprising a first component in a first receptacle that comprises the dispersing agent and a second component in a second receptacle that comprises the coagulating agent. This offers the possibility of individual dosing of the dispersant and the coagulating agent depending on the specific application. Thus, a two-component composition can be used in a highly flexible manner.

According to another preferred embodiment, the kit-of-parts is present in the form of a three-component composition or a multi-component composition with more than three components. In this case, for example, the three-component composition comprises a first component in a first receptacle that comprises the dispersing agent, a second component in a second receptacle that comprises a first coagulating agent and a third component in a third receptacle that comprises a second coagulating agent. Thereby the first and the second coagulating agents are chemically and/or physically different. This allow for providing a kit-of-parts, which allows for adapting the coagulating agent to specific needs, e.g. to different clays containing slurries and/or to different processing conditions.

Likewise it is possible to provide a the three-component composition that comprises a first component in a first receptacle that comprises a first dispersing agent, a second component in a second receptacle that comprises a second dispersing agent, and a third component in a third receptacle that comprises a coagulating agent. Thereby the first and the second dispersing agents are chemically and/or physically different. This allow for providing a kit-of-parts, which allows for adapting the dispersing agent to specific needs, e.g. to different clays containing slurries and/or to different processing conditions.

According to another preferred embodiment, the additive is present in the form of a one-component composition, whereby the additive comprises a mixture of the dispersing agent and the coagulating agent in a common receptacle. This makes handling easier and reduces the risk of incorrect dosing of the dispersant and coagulating agent.

In all of the above described embodiments and variants, the additive is essentially free of hydraulic binders and/or clays. This means that with respect to the overall weight of the additive, a proportion of these substances is below 1% by weight, especially below 0.5% by weight, in particular below 0.1% by weight or 0% by weight. Put differently, before using the additive for producing a hardenable building material, it is essentially free of cement and/or clays.

A further aspect of the present invention is an aqueous slurry, especially a workable composition, comprising an additive as described above, mineral particles comprising clays, and water.

In particular, the clays consist of particles with a particle size smaller than 4 µm, more preferably smaller than 2 µm. The particle sizes are d₉₀-values, which are determined by laser diffraction, especially according to standard ISO 13320:2009. Thus, 90% of the particles are smaller than the given particle sizes. Clay particles are preferably hydrated aluminosilicate particles.

Preferably, the clays comprise phyllosilicate minerals. Especially, the clays are 2:1 clays. These are clays in which an octahedral sheet is sandwiched between two tetrahedral sheets. Especially, the clays comprise or consist of kaolinite, smectite, montmorillonite, illite, bentonite, and/or hectorite.

Particularly, the aqueous slurry comprises at least 5% by weight, preferably 5 to 30% by weight of clays, preferably 10 to 25% by weight of clays, based on the total dry weight of the dry mineral particles in the slurry.

According to a preferred embodiment, the aqueous slurry comprises clay particles, silt, sand and gravel. Especially, the aqueous slurry comprises about 5 to 30% by weight of clay particles, 5 to 10% by weight of silt, 25 to 55% by weight of sand and 20 to 47% by weight of gravel, based on the total dry weight of dry the mineral particles in the slurry. In this case, the slurry can be used to produce concrete-like building materials, e.g. for producing walls, floors or ceilings. Furthermore, in this case, if the additive in the slurry comprises an alkali metal silicate as a dispersing agent, the molar ratio of the Si to the alkali metal preferably is > 2, especially 2.6. In this case, preferably, the alkali metal silicate is a sodium silicate.

In another preferred embodiment, the aqueous slurry comprises clay particles, silt and sand. Especially, the aqueous slurry comprises about 7 to 40% by weight of clay particles, 7 to 13% by weight of silt, and 33 to 75% by weight of sand, based on the total dry weight of dry the mineral particles in the slurry. In this case, the slurry can be used to produce mortar-like building materials, e.g. for producing bricks. In Furthermore, in this case, if the additive in the slurry comprises an alkali metal silicate as a dispersing agent, the molar ratio of the Si to the alkali metal preferably is < 2, especially 1.8. In this case, preferably, the alkali metal silicate is a sodium silicate.

In the present context, the particle size of silt particles is < 100 µm, whereas the particle size of sand is between 100 µm and 4 mm, whereas the particle size of gravel is above 4 mm, typically up to 64 mm. In this case, the particle size is measured by sieve analysis as described above. Particles with a size < 100 µm are called “fines”.

Within the present context, if not otherwise defined, the particle size is determined by sieve analysis, in particular with sieves featuring square openings. Especially, the particle size is expressed by the opening size of the test sieves just passed by the grains or particles concerned.

Preferably, the aqueous slurry is essentially free of hydraulic binders, especially free of cement. This means that with respect to the overall weight of the aqueous slurry, a proportion of hydraulic binders is below 1% by weight, especially below 0.5% by weight, in particular below 0.1% by weight.

Furthermore, preferably, based on the total dry weight of fines having a particle size below 100 µm, a proportion of pozzolanic and/or latent hydraulic binders in the aqueous slurry is below 3% by weight, especially below 2% by weight, in particular below 1% by weight. In a special embodiment, the aqueous slurry is free of pozzolanic and/or latent hydraulic binders.

In particular both of the conditions mentioned in the two last paragraphs are met together.

In the present context, “hydraulic binders” are meant to be mineral binders, which react in the presence of water in a hydration reaction to form solid hydrates or hydrate phases.

This can be, for example, cement, lime, or gypsum. Latent hydraulic binders (for example, slag) or pozzolanic binders (for example fly ash) are not considered hydraulic binders.

The quantity of water can be varied according to the intended use and is generally chosen so that the aqueous slurry is fluid. For example, a ratio of water to mineral particles between 0.1 and 0.6 is suitable for most applications.

Preferably, the aqueous slurry contains 5 - 80% by weight, in particular 10 - 70% by weight, especially 15 - 60% by weight, of water, with respect to the overall weight of the slurry. For example, the proportion of water is about 15 - 40% by weight, with respect to the overall weight of the slurry.

Especially, the aqueous slurry comprises 0.01 - 2% by weight, especially 0.02 - 1% by weight, in particular 0.05 - 0.3% by weight, of the dispersing agent, based on the total dry weight of fines having a particle size below 100 µm in the slurry.

Preferably the aqueous slurry comprises 0.01 - 2% by weight, especially 0.02 - 1% by weight, in particular 0.05 - 0.3 % by weight, of the coagulating agent, based on the total dry weight of fines having a particle size below 100 µm in the slurry.

Especially, the aqueous slurry comprises the dispersing agent and the coagulating agent such that a total amount of dispersing agent and the coagulating agent together is 0.01 -1% by weight, in particular 0.05 - 0.8% by weight, based on the total dry weight of fines having a particle size below 100 µm.

In particular, the aqueous slurry comprises the dispersing agent and the coagulating agent in such a proportion that such a total amount of dispersing agent and the coagulating agent together is 0.01 - 1% by weight, in particular 0.05 - 0.8% by weight, based on the total dry weight of solid components in the slurry.

In particular both of the conditions mentioned in the two last paragraphs are met together.

Especially, the aqueous slurry, based on the total dry weight of fines having a particle size below 100 µm in the slurry, comprises 0.01 - 2% by weight, especially 0.02 - 1% by weight, in particular 0.05 - 0.5% by weight, of pozzolanic material, especially fly ash.

Another aspect of the present invention is related to a hardened composition obtainable or obtained by letting hardening an aqueous slurry as described above.

Furthermore, the invention is concerned with several uses of the inventive additive or an inventive aqueous slurry as described above.

For example, the additive or the aqueous slurry can be used for producing a hardenable building material, preferably substantially free of hydraulic binder, from mineral particles comprising clays, especially from a clay containing mineral fraction of soil.

Furthermore, the additive or the aqueous slurry can be used for producing a molded and/or formed body from mineral particles comprising clays. Thereby, for example, the additive or the aqueous slurry is used to produce a hardenable building material, which then is allowed to harden in order to obtain the formed body. The formed body can e.g. be a wall, a floor, a ceiling, a brick, a panel, a clay panel, a slab and/or a pillar.

For example, when producing formed bodies such as e.g. bricks, clay containing materials obtained from clay quarries or clay pits can be used as the mineral particles comprising clays. In this case, there is in principle no need to add further aggregates. Nevertheless, this is of course possible of desired.

Especially, when producing a formed body, the mineral particles comprising clays and/or the hardenable building material produced thereof, are subjected to a temperature of at least 50° C., in particular of 60 - 100° C. or 400 - 600° C., for hardening. This helps to harden the solid building material. Most preferred temperatures are within the range of 60 - 100° C.

As it turned out, with a hardenable building material according to the invention, which is subjected to a temperature of at least 50° C., in particular of 60 - 100° C., for hardening, it is possible to produce bricks with a compressive strength and a bending strength usually obtainable with ordinary bricks calcined at about 500° C. Thus, the inventive additive improves the mechanical properties, especially the compressive strength, significantly without need of high temperatures. Thus, the process can be performed with much less energy.

For all the uses, preferably, the additive is added such that a proportion of the dispersing agent is 0.01 - 2% by weight, especially 0.02 - 1% by weight, in particular 0.05 - 0.3% by weight, based on the total dry weight of fines having a particle size below 100 µm and/or the coagulating agent has a proportion of 0.01 - 2% by weight, especially 0.02 - 1% by weight, in particular 0.05 - 0.3% by weight, based on the total dry weight of fines having a particle size below 100 µm.

Especially, for all the uses, the additive is added such that a proportion of the dispersing agent and the coagulating agent together is 0.01 - 1% by weight, in particular 0.05 - 0.8% by weight, based on the total dry weight of fines having a particle size below 100 µm.

In particular, for all the uses, the additive is added such that a proportion of the dispersing agent and the coagulating agent together is 0.01 - 1% by weight, in particular 0.05 - 0.8% by weight, based on the total dry weight of all of the solid components.

According to a highly preferred embodiment, when using the additive, all of the components of the additive are added to the mineral particles comprising clays simultaneously and/or the additive is added to the mineral particles comprising clays as a one-component additive. This is especially beneficial when producing bricks from aqueous slurries for mortar-like slurries as described above.

Preferably, when using the additive, it is mixed with the mineral particles comprising clays with low shear stress. This helps to avoid abrasion of the particles. Nevertheless, it is preferred to produce a mixture as homogeneous as possible, e.g. by using larger mixing elements.

A further aspect of the present invention is directed to a process for the manufacture of a solid building material, preferably a solid building material which is substantially free of hydraulic binder, comprising the steps of:
i) extracting a mineral fraction comprising clays from a soil
ii) optionally adjusting the particle size of the mineral fraction extracted, in particular with respect to its clay, sand, gravel or silt content,
iii) preparing a first aqueous slurry from at least a portion of the extracted and optionally graded mineral fraction,
iv) adding the above described dispersing agent capable of dispersing the clay particles to the first aqueous slurry to obtain a second aqueous slurry,
v) adding the above describe coagulating agent capable of causing agglomeration of the clay particles to the second aqueous slurry to obtain an aqueous building material slurry,
vi) introducing the slurry of aqueous building material into a formwork, and
vii) allowing the slurry of aqueous building material to harden so as to obtain a solid building material.

Thereby, preferably, the solid building material is a load-bearing element having a compressive strength of at least 1.4 MPa.

Especially, the solid building material is a formed body, e.g. a wall, a floor, a ceiling, a brick, a panel, a slab and/or a pillar. Especially, the formed body is a clay brick and/or a clay panel.

Extraction of the mineral fraction comprising clays can be carried out on site, e.g. by means of soil excavation, thus avoiding the need to transport mineral materials such as clay, silt, sand and/or gravel to the construction or production site. Clays, silt, sand and gravel are defined as described above.

For example, the soil is a clay containing materials obtained from clay quarries or clay pits. In this case, all of the components, such as silt, sand, gravel and/or pebbles, can in principle be obtained from the clay quarries or clay pits on site. This is especially beneficial for producing formed bodies such as e.g. bricks.

Adjustment of the grain size of the extracted mineral fraction may be carried out on site by means of sieving or sedimentation of the extracted mineral fraction or, where the grain size of the local extracted mineral fraction so requires, the composition of the mineral fraction may be supplemented by the addition of additional mineral fractions to achieve the desired grain size, such as silt, sand, gravel or pebbles. The content of the mineral fraction in terms of silt, sand, gravel or pebbles will depend on the requirements of the building material and its intended use.

Preferred compositions for preparing mortar-like or concrete-like slurries are described above in connection with the aqueous slurries. Likewise, proportions of clays, sand, gravel and water are preferably chosen as described above.

The preparation of the first aqueous slurry to be mixed with at least a part of the extracted mineral fraction, which has optionally been adjusted with respect to grain size, can e.g. be carried out by mixing at least a part of the extracted mineral fraction with an aqueous solution or water, for example in a concrete mixer. The amount of water can be varied according to the intended use and is generally chosen so that the slurry is fluid. For example, a water/mineral fraction ratio between 0.1 and 0.6 is chosen. Or a water/mineral fraction ratio is choses so that a flow table spread after vibration between 30 and 50 cm is achieved.

The addition of a dispersing agent to the first slurry to obtain a second aqueous slurry is preferably carried out when the first slurry water was mixed while continuing the mixing action. The addition can be done either by adding the dispersing agent in solid form or as an aqueous dispersion or solution.

Preferably, with the addition of the dispersing agent to the first slurry, a slurry with increased fluidity, i.e. a yield stress of less than 1′000 Pa, preferably less than 250 Pa, is obtained.

This allows for a reduction of water required to achieve a fixed flow threshold of the slurrycompared to a slurry without dispersing agent. When the yield stress is lower than 1′000 Pa, the grout becomes easier to work, mold, form and/or pump.

To determine the yield stress or dimensional change strength of the slurries, flow tests to determine the flow diameter of the freshly prepared slurries are performed in a first step. To do so, a hollow cylinder with a volume of 99 cm³, open on both sides and standing on a flat glass plate, is filled with freshly prepared slurry and then pulled away vertically. After the end of the spreading movement, the diameter of the binder composition that had spread out in the plane of the glass plate and/or horizontally is measured. The yield stress or the resistance to deformation of the slurry was determined according to the equation (i) from the volume V of the binder composition, the density p (=weighed mass of the binder composition/volume V) and the measured diameter d (=2 R):

$${τ}_{0} = \frac{\frac{225 ⋅ ρ ⋅ g ⋅ {V}^{2}}{128 ⋅ {π}^{2} ⋅ {R}^{5}}}{1 + \frac{225 ⋅ {3}^{1 / 2} ⋅ V}{128 ⋅ π ⋅ {R}^{3}}} - \frac{λ ⋅ {R}^{2}}{V}$$

where g is the acceleration due to gravity and λ is a constant coefficient for the test setup, which depends on the surface tension and the contact angle of the binder composition on the test surface. In the present case, λ=0.005 can be used for the calculation. Details about equation (i) and/or λ can be found in J. Zimmermann, C. Hampel, C. I<urz, L. Frunz, and R. J. Flatt, “Effect of polymer structure on the sulphate- polycarboxylate competition”, Proc. 9th ACI Int. Conf. Superplasticizers and Other Chemical Admixtures in Concrete, (editors: T. C. Holland, P. R. Gupta, V. M. Malhotra), American Concrete Institute, Detroit, SP-262-12 (2009) pp. 165-176 as well as the references cited therein.

The addition of the dispersing agent and the coagulating agent in steps (iv) an (v) can be done consecutively or simultaneously.

According to a highly preferred embodiment, all of the components of the additive are added to the extracted and optionally graded mineral fraction simultaneously and/or the additive which is added to the extracted and optionally graded mineral fraction is as a one-component additive. This is especially beneficial when producing mortar-like materials, such as e.g. bricks. However, it can also be beneficial when producing concrete-like materials.

Furthermore, in another preferred embodiment, the dispersing agent and the coagulating agent, or the one-component additive, is simultaneously added when preparing the aqueous slurry from at least a portion of the extracted and optionally graded mineral fraction in step iii).

Preferably, when adding the coagulating agent and/or the dispersing agent, the slurries are mixed with low shear stresses. This helps to avoid abrasion of the particles. Nevertheless, it is preferred to produce slurries as homogeneous as possible, e.g. by using larger mixing elements.

Preferably, the dispersing agent is added with a proportion of 0.01 - 2% by weight, especially 0.02 - 1% by weight, in particular 0.05 - 0.3% by weight, based on the total dry weight of fines having a particle size below 100 µm.

The addition of the coagulating agent can be done either by adding the coagulating agent in solid state or in the form of an aqueous dispersion or solution.

Preferably, the addition of the coagulating agent to the second slurry to obtain an aqueous building material slurry is preferably carried out when the second aqueous slurry has reached a yield stress of less than 1′000 Pa and more preferably when the second aqueous slurry has reached a yield stress of less than 1′000 Pa and prior to molding of the aqueous building material slurry.

Preferably, the coagulating agent is added with a proportion of 0.01 - 2% by weight, especially 0.02 - 1% by weight, in particular 0.05 - 0.3% by weight, based on the total dry weight of fines having a particle size below 100 µm.

Especially, the dispersing agent and the coagulating agent are such that a total proportion of the dispersing agent and the coagulating agent together is 0.01 - 1% by weight, in particular 0.05 - 0.8% by weight, based on the total dry weight of fines having a particle size below 100 µm.

In particular, the dispersing agent and the coagulating agent are such that a total proportion of the dispersing agent and the coagulating agent together is 0.01 - 1% by weight, in particular 0.05 - 0.8% by weight, based on the total dry weight of all of the solid components in the slurry.

In general, the coagulating agent may be derived from the extraction of the corresponding mineral in a quarry. Although ores contain a majority of the coagulating agent, these ores also contain impurities that may interfere with the coagulation action and it is therefore preferable to use coagulating agents of increased purity, i.e. having a purity of at least 85% by weight, more preferably of at least 95% by weight, with respect to the overall weight of the coagulating agent.

It has been shown that the use of coagulating agents with increased purity also leads to higher mechanical properties in the hardened building material as well as an acceleration of the setting. On the other hand, the use of coagulating agents with reduced purity, i.e. with a purity of less than 85% by weight, leads to an extension of the time during which the grout remains workable.

In a particular implementation of the method according to the present invention, the addition of the dispersing agent and the coagulating agent to finally obtain a slurry of aqueous building material takes place simultaneously.

If the addition of the dispersing and coagulating agent is carried out simultaneously, it is preferable to add the dispersing and coagulating agent in solid form, i.e. in the form of particles such as powder, sand or granules.

In another implementation, the dispersing agent and the coagulating agent are added one after the other.

If the dispersing and coagulating agent is added sequentially, i.e. first the dispersing agent and then the coagulating agent, it is preferable to add the dispersing agent, the coagulating agent or both in the form of an aqueous solution or dispersion in order to better control the duration of the workability or the setting of the building material slurry.

In a particular realization of the method according to this invention, the building material is a building block, preferably in the form of a parallelepiped such as a brick, in particular a load-bearing brick or other load-bearing elements such as a wall, a slab or a pillar.

The present invention further provides a solid building material obtained by the process according to any of the variants of the above-mentioned process, having a compressive strength of at least 1.4 MPa, and more particularly of at least 3 MPa or 3 to 25 MPa, which is substantially free of hydraulic binder.

A compressive strength in this range makes it possible to manufacture building blocks or vertical walls suitable for the construction of houses or buildings with up to four storeys without the use of materials such as hydraulic binders and by using a small amount of additives such as dispersing agent and coagulating agent. It is important to mention that a compressive strength of at least 1.4 MPa can be obtained after 24 hours of hardening, which allows construction progress with approximately the same pitch as if the building material used is mortar or concrete.

In the present context, tests for the determination of the compressive strength (in N/mm² or MPa) are carried out following standard EN 12390-1:2012, EN 12390-2:2019, EN 12390-3:2019 and 12390-4:2000 with prisms (40×40× 160 mm). The flow table spread (FTS) of the mortar is determined according to EN 1015-3:2007.

Further advantageous embodiments and combinations of features of the invention result from the following detailed description and the patent claims.

### BRIEF DESCRIPTION OF THE DRAWINGS

The drawings used to explain the examples show:

FIG. 1 a comparison of the dispersing effects of two different dispersing agents on the yield stress of an aqueous slurry;

FIG. 2 a comparison of the interplay between MgO as coagulating agent and three different dispersing agents (sodium hexametaphosphate; sodium silicate; and sodium polyacrylate) in aqueous slurries;

FIG. 3 a comparison of the effects of different couples of dispersing agents and coagulating agents on the yield stress of an aqueous slurry;

FIG. 4 the effect of fly ash on the dispersing effect of sodium hexametaphosphate;

FIG. 5 the effectivity of three different sodium silicate dispersants with different Si/Na ratios;

FIG. 6 a comparison of molded bodies obtained with (left side) and without (right side) using a coagulating agent.

### EXAMPLES

### Additive Components and Additives

Table 1 shows several dispersing agents whereas table 2 shows different coagulating agents, which can be used in the inventive additives. In table 3, two specific additives are shown. All substances used are commercially available.

TABLE 1

Dispersants

| No. | Na-hexameta-phosphate [g] | Al₂O₃ [g] | Na-metasilicate [g] | Na-polyacrylate [g] | Fly ash [g] |
|---|---|---|---|---|---|
| D1 | 0.05 | 0.02 | - | | - |
| D2 | 0.10 | - | 0.05 | | - |
| D3 | 0.072 | - | | | 0.36 |
| D4 | 0.20 | - | - | | - |
| D5 | 0.10 | - | 0.10 | | - |
| D6 | - | - | 0.20 | | - |
| D7 | - | - | - | 0.20 | - |

TABLE 2

Coagulating agents

| | | |
|---|---|---|
| No. | Substance/ [g] | Fly ash [g] |
| C1 | MgO/0.05 | 0.02 |
| C2 | MgO/0.10 | - |
| C3 | CaCl/0.10 | - |
| C4 | CaSO₄·2 H₂O/0.10 | - |
| C5 | MgSO₄/0.10 | - |
| C6 | Ca(NO₃)₂·4 H₂O/0.10 | - |
| C7 | Ca(OH)₂/0.10 | - |

TABLE 3

Additives

| No. | Na-hexametaphosphate [g] | MgO [g] | Fly ash [g] |
|---|---|---|---|
| A1 | 0.14 | 0.14 | 1 |
| A2 | 0.07 | 0.07 | 1 |

Additives A1 and A2 have been provided as two-component compositions with the dispersing agent and the coagulating agent in two separate receptacles.

### Tests

For testing the effectiveness of the dispersing agents or coagulating agents, respectively, an aqueous slurry comprising 60% by weight of clays and 40% by weight of water was produced. Subsequently, the slurry has been treated with one of the dispersing agents and/or the coagulating agents (for proportions see below).

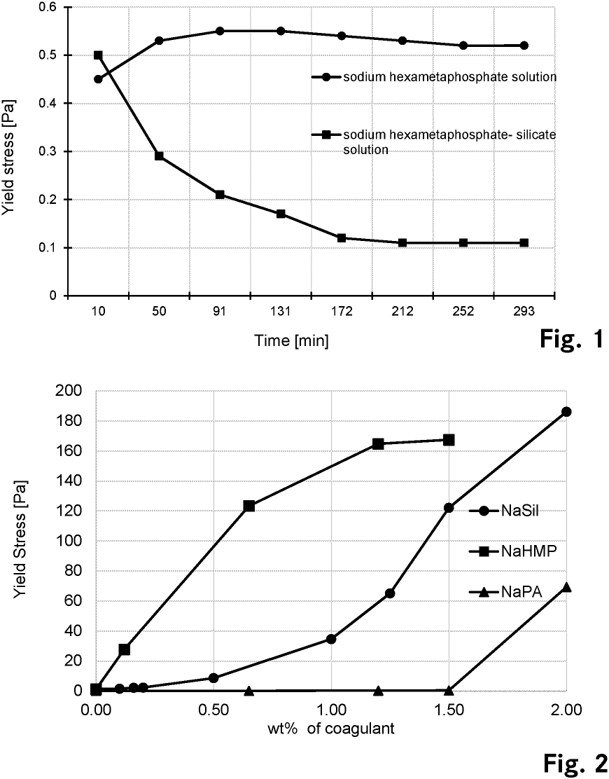

FIG. 1 shows a comparison between dispersing agent D4 and D5. Both dispersing agents have been added in a proportion of 0.2% by weight with regard to the dry weight of the total weight of fines in the slurry.

As evident from FIG. 1, dispersing agent D5 comprising a combination of sodium hexametaphosphate and sodium silicate is more effective in reducing the yield stress of the slurry with increasing time.

FIG. 2 shows a comparison of the interplay between the coagulating agent C2 (MgO) and three different dispersing agents D4 (NaHMP = sodium hexametaphosphate), D6 (NaSil = sodium silicate) and D7 (NaPA = sodium polyacrylate). Thereby, the proportions of the dispersing agents were kept constant. It can be seen that the effectiveness of the coagulating agent depends on the nature of the dispersing agent used and the concentration of the coagulating agent. Increasing the coagulating agent proportion or the coagulating agent/dispersing agent ratio speeds up the setting of the slurry.

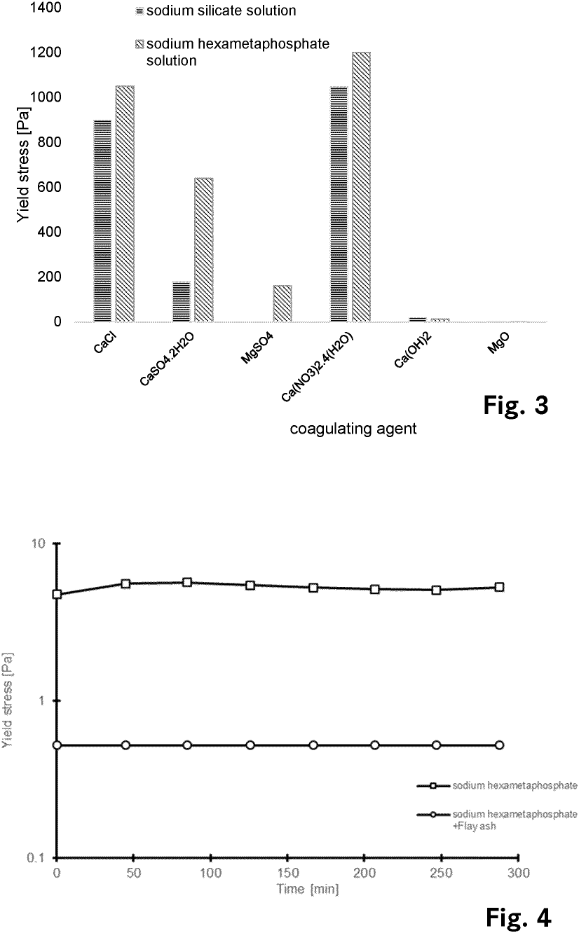

FIG. 3 shows a comparison of the yield stress of different couples of dispersing agents (D4, D6) and coagulating agents (C2 - C7) right after addition of the additives. Thereby, the proportions of the dispersing agent and the coagulating agent were kept constant. As can be seen from FIG. 3, when using calcium chloride, calcium sulphate or calcium nitrate as the coagulating agent, there is a rapid increase in the yields stress. The highest increase is achieved with sodium hexametaphosphate as the dispersing agent. Having a quick setting opens doors for applications such as the production of bricks, panels, plaster and the like.

On the other hand MgO, Ca(OH)₂ or CaO as coagulating agents delay the setting. Thus, with these coagulating agents, it is possible to provide slurries with a relatively long workability what important e.g. for applications such as poured earth concrete, floor slabs and the like.

FIG. 4 shows the effect of a partial replacement of sodium hexametaphosphate by fly ash. Sodium hexametaphospate alone (line with square symbols) was used in a proportion of 0.2% by weight with regard to the dry weight of the total weight of fines in the slurry. For the test with flay ash (line with circle symbols), with regard to the dry weight of the total weight of fines in the slurry, a combination of 0.1% by weight of sodium hexametaphosphate and 0.15% by weight of fly ash was used. As can be deduced, the yield stress can be reduced significantly when using fly ash. Since fly ash in general is relatively cheap, this is a highly interesting effect, which allows for reducing the amount of sodium hexametaphosphate and other dispersing substances.

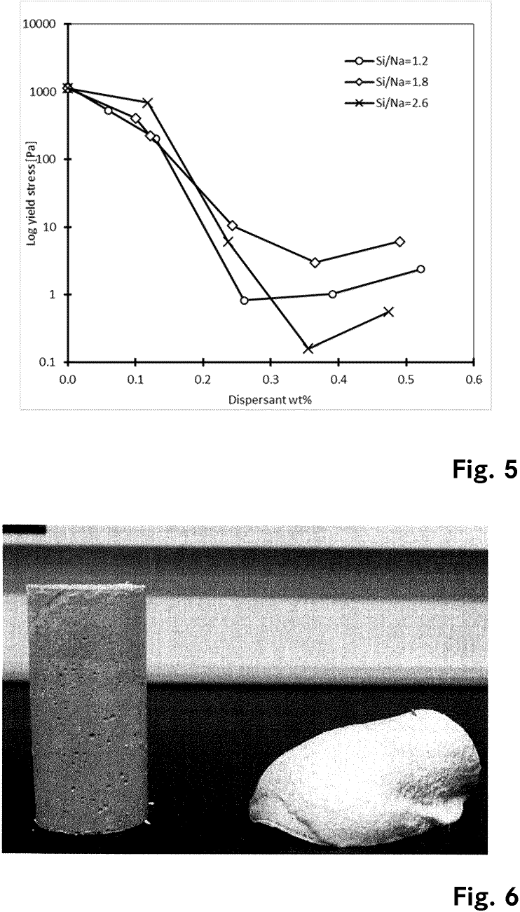

For reasons of comparison, FIG. 5 shows the effectiveness of three different sodium silicate dispersants with different Si/Na ratios.

### Mortar-Like Building Materials

A mortar-like building material was produced by mixing, based on the dry weight of the mineral particles, 28% by weight of clays and 72% by weight of sand (< 4 mm). Subsequently, water was added in order to produce an aqueous slurry with a proportion of 14% by weight of water with respect to the overall weight of the slurry. The aqueous slurry then was treated in a first step with the dispersing agent of additive A1 in order to dispense the particles and in a second step with the coagulating agent of additive A2 in order to initiate coagulation of the slurry. The concentration of the dispersing agent was about 0.2% by weight, based on the total dry weight of fines having a particle size below 100 µm. Likewise (if used) the proportion of the coagulating agent, was about 0.2% by weight, based on the total dry weight of fines having a particle size below 100 µm.

In fresh state, the aqueous slurry or the workable mortar-like composition, respectively, in this case has a flow table spread of about 40 - 55 cm.

For reasons of comparison, a similar slurry was produced. However, in this case, the coagulating agent was omitted. FIG. 6 shows a comparison of the molded bodies obtained with (left side) and without (right side) coagulating agent.

As can be seen from the object on the right side of FIG. 6, without the addition of the coagulating agent, the mortar composition collapses after 24 hours, whereas in the presence of the coagulating agent (left side of FIG. 6), a self-supporting molded body is obtained.

Measurements of the compressive strength in line with the standards described above (using prisms of 40×40×160 mm), showed that when using the dispersing agent in combination with the coagulating agent (additive A1), compressive strength after 14 days of about 5.5 MPa are obtained. In contrasts, when omitting the coagulating agent, the maximum compressive strength observed after 14 days was about 3 MPa.

### Production of Bricks

Furthermore, based on compositions comprising clays, sand, water and inventive additives, uncalcined bricks with a final compressive strength of about 15 MPa could be produced. With additional calcination at a temperature of 800° C., bricks with a compressive strength of about 20 MPa were obtained.

Without addition of the inventive additives, the compressive strength obtainable was about half of the values mentioned above.

### Production of Concrete-Like Materials

Based on compositions comprising clays, sand, gravel water and inventive additives concrete-like materials could be produced with a final compressive strength of about 3 MPa (measured in cubes of 15×15×15 mm).

We claim:

1-29. (canceled)

30. An additive for producing a hardenable building material comprising:
a) a dispersing agent, selected from aluminates, aluminate precursors, phosphates, silicates and/or polyacrylates, which is capable of dispersing clay particles in an aqueous slurry,
b) a coagulating agent, selected from salts of divalent metal cations, which is capable of causing clay particles to agglomerate in an aqueous slurry.

31. The additive according to claim 1, whereby the dispersing agent comprises a polymetaphosphate, an alkali metal silicate, NaAlO₂,Na₂Al₂O₄ and/or Al₂O_{3.}

32. The additive according to claim 1, whereby the dispersing agent comprises a phosphate and a further dispersant from the group consisting of aluminates, aluminate precursors, silicates and/or polyacrylates.

33. The additive according to claim 3, whereby a weight ratio of the phosphate to the further dispersant is in the range of 0.5 - 10.

34. The additive according to claim 3, whereby a weight proportion of the phosphate is higher than a weight proportion of the further dispersant.

35. The additive according to claim 1, whereby the dispersing agent furthermore comprises a pozzolanic compound, whereby a weight ratio of the pozzolanic compound to the dispersing substance(s) is in the range of 1 - 15.

36. The additive according to claim 6, whereby the pozzolanic compound is selected from fly ash.

37. The additive according to claim 1, whereby the coagulating agent comprises magnesium oxide and/or calcium oxide.

38. The additive according to claim 1, whereby a weight ratio of the dispersing agent to the coagulating agent is in the range of 0.1 - 10.

39. The additive according to claim 1, comprising:
a) a dispersing agent comprising a phosphate and a further dispersant selected from the group consisting of aluminates, aluminate precursors, silicates, polyacrylates and combinations thereof, and
b) a coagulating agent selected from the group consisting of magnesium oxide, calcium oxide and combinations thereof.

40. The additive according to claim 1, comprising:
a) a dispersant comprising:
sodium hexametaphosphate;
sodium aluminate;
whereby a weight ratio of the phosphate to the aluminate is in the range of 2 - 4;
optionally a pozzolanic compound;
whereby, if a pozzolanic compound is present, a weight ratio of the pozzolanic compound to the other dispersing substances is in the range of 3 - 7;
b) a coagulating agent comprising:
magnesium oxide
optionally a pozzolanic substance
whereby, if a pozzolanic compound is present, a weight ratio of the pozzolanic compound to the other coagulating substances is in the range of 3 - 12; and
whereby a weight ratio of the dispersing agent to the coagulating agent is in the range of 0.7 - 1.5.

41. The additive according to claim 1, whereby the additive is a kit-of-parts being present in the form of a multi-component composition comprising a first component in a first receptacle that comprises the dispersing agent and a second component in a second receptacle that comprises the coagulating agent.

42. The additive according to claim 1, whereby the additive is essentially free of hydraulic binders and/or clays.

43. The additive according to claim 1, whereby a particle size of the dispersing agent is ≤ 1′100 µm and whereby a particle size of the coagulating agent is ≤ 1′100 µm.

44. The aqueous slurry of claim 1, comprising an additive according to claim 1, mineral particles comprising clays, and water, whereby the aqueous slurry is essentially free of cement.

45. The aqueous slurry according to claim 44, containing 5-80% by weight, in particular 10-70% by weight, especially 25-60% by weight, of water, with respect to the overall weight of the slurry.

46. The aqueous slurry according to claim 44, comprising 0.01-2% by weight of the dispersing agent, based on the total dry weight of fines having a particle size below 100 µm in the slurry, and comprising 0.01-2% by weight of the coagulating agent, based on the total dry weight of fines having a particle size below 100 µm in the slurry.

47. A method for the manufacture of a solid building material comprising the steps of:
(i) extracting a mineral fraction comprising clay particles from a soil
(ii) optionally adjusting the particle size of the mineral fraction extracted with respect to its clay, sand, gravel or silt content,
(iii) preparing a first aqueous slurry from at least a portion of the extracted and optionally graded mineral fraction,
(iv) adding a dispersing agent as defined in claim 1, which capable of dispersing the clay particles to the first aqueous slurry to obtain a second aqueous slurry,
(v) adding a coagulating agent as defined in claim 1, which is capable of causing agglomeration of the clay particles to the second aqueous slurry to obtain an aqueous building material slurry,
(vi) introducing the slurry of aqueous building material into a formwork, and
(vii) allow the slurry of aqueous building material to harden so as to obtain a solid building material.

48. The method according to claim 47, whereby the solid building material manufactured is a brick or a clay panel.
